(19) United States
(12) Patent Application Publication
(10) Pub. No.: US 2022/0392377 A1
(43) Pub. Date: Dec. 8, 2022

(54) MODEL CONSTRUCTION KIT

(71) Applicant: IDEA VAULT HOLDINGS INC, Ashland, OR (US)

(72) Inventors: Jordan M. Willing, Ashland, OR (US); Michael E. Munter, Ashland, OR (US); Joshua J. Gedlick, Ashland, OR (US)

(21) Appl. No.: 17/835,488

(22) Filed: Jun. 8, 2022

Related U.S. Application Data
(60) Provisional application No. 63/208,441, filed on Jun. 8, 2021.

(51) Int. Cl. G09B 23/40

(52) U.S. Cl. CPC G09B 23/40

(57) ABSTRACT

Disclosed is an improved model kit including a plurality of support members for constructing a hollow frame upon which one or more surfaces can be constructed. The kit may include flat support members having slots, a first material which is in the shape of a flat sheet when fully extended, and which becomes self-adhering when saturated with water and which dries into a hardened material, a second material which becomes moldable when saturated with water and which dries into a hardened material, where the plurality of flat members are configured to interconnect with each other to form a hollow frame, where the first material can be laid over the hollow frame to form a first surface, and where the second material can be laid over the first surface to form a second surface. The improved model kit may be efficient, cost-effective, visually appealing, easy to assemble, and compact when stored.

### CROSS-REFERENCE TO RELATED APPLICATION

This application claims priority to and the benefit of U.S. Provisional Patent Application No. 63/208,441, filed on Jun. 8, 2021, the entire contents of which is incorporated herein by reference.

### BACKGROUND

Models are commonly used in science kits to teach students about topics of interest, including children. To aid in the learning experience as well as provide an entertaining activity, science kits with components for students to construct their own models are often provided. Many prior art science kits utilize models which are composed of molded plastic components, wood, or metals, which are bulky, relatively heavy, and have a high cost relative to the price of the kit. This has led many manufacturers of such science kits to utilize miniaturized models in order to reduce costs, or, alternatively, increasing the price of the kits having larger models. Thus, it has been difficult to provide science kits complete with non-miniature sized models for construction by the end user at a competitive price while also remaining profitable for the manufacturer.

For example, one sort of model science kit which is popular among students is a volcano science kit, where students construct a model of a volcano and fill it with chemically reactive ingredients to observe the effect of a sudden release of energy in a bounded environment. Like many other prior art science kits, prior art volcano science kits have utilized undesirable miniaturized models, or bulky molds for non-miniaturized models which occupy large volumes, and which increase materials costs for the manufacturer. There remains a need in the art for cost effective, and compact science kits that can be offered to consumers at a competitive and profitable price, including, for example, volcano science kits.

### SUMMARY

It is appreciated by the inventors that prior art model science kits with non-miniaturized models are difficult to profitably commercialize due to the high materials costs, and other logistical costs in producing, storing, and shipping bulky structures. In response to the failure of prior art model science kits to produce full sized model structures which are effective, appealing, easy to assemble, and which can be stored compactly, disclosed is a model science kit and method of use including a plurality of support members used to construct a hollow frame, upon which a first surface may be constructed.

In one or more embodiments, a plurality of flat members each comprising at least one slot, a first material which is in the shape of a flat sheet when fully extended, and which becomes self-adhering when saturated with water and which dries into a hardened material, a second material which becomes moldable when saturated with water and which dries into a hardened material, where the plurality of flat members are configured to interconnect with each other to form a hollow frame, where the first material can be laid over the hollow frame to form a first surface, and where the second material can be laid over the first surface to form a second surface.

### BRIEF DESCRIPTION OF THE DRAWINGS

FIG. 1 shows a perspective view of an assembled model science kit of one or more embodiments, and, for example, an assembled model volcano science kit;

FIG. 2 shows the unassembled components of a model science kit of one or more embodiments;

FIG. 3 shows a perspective view of a partially assembled model science kit of one or more embodiments assembled as to the lower level;

FIGS. 4-6 show perspective views of a partially assembled model science kit of one or more embodiments assembled as to the mid-level;

FIG. 7-10 show perspective views of a partially assembled model science kit of one or more embodiments assembled as to the upper-level;

FIG. 11 shows a perspective view of additional kit components of the model science kit of one or more embodiments;

FIG. 12 shows a perspective view partially assembled model science kit of one or more embodiments with additional kit components;

FIGS. 13-14 show a perspective views of a partially assembled model science kit of one or more embodiments assembled as to an outer surface;

FIG. 15 shows a perspective view of additional kit components of the model science kit of one or more embodiments.

### DETAILED DESCRIPTION

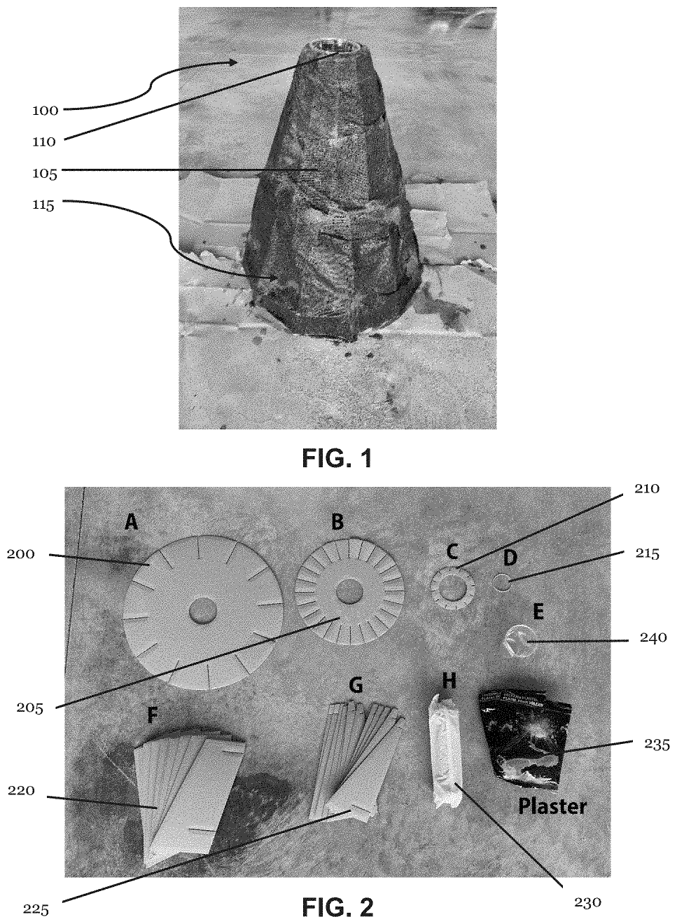

Referring to FIGS. 1-2, illustrated is a perspective view of an assembled model science kit of one or more embodiments, and, for example, an assembled model volcano 100. The improved model construction kit may be constructed in a variety of shapes, including, for example, cones, spheres, cylinders, ovoids, polygonal prisms, wings, model airplanes, model boats, other models of transportation devices, wheels, towers, buildings, mountains, cliffs, roads, and a variety of other additional structures which may be useful to model. For example, a model volcano 100 may generally be constructed in the shape of a blunt tipped cone with an upper opening 110, and a first surface 115 defined by a flexible, moldable material that connects the spaces 105 between the frame.

In a given embodiment for constructing a model volcano, components of the improved model construction kit may comprise a first flat base member 200, a second flat base member 205, a third flat base member 210, a fastener 215, a plurality of first flat connecting members 220, a plurality of second flat connecting members 225, rolled plaster wrap 230 which becomes self-adhering when saturated with water and which dries into a hardened material, plaster powder 235 which becomes moldable when saturated with water and which dries into a hardened material, a reactant vessel 240, and plaster applicator, among other possible components.

Components of the improved model construction kit may comprise a plurality of flat members each comprising at least one slot. The flat member may have a low vertical profile when positioned parallel to an x-y plane along their largest face, and may be constructed from a variety of materials that can be formed into a generally flat shape while still maintaining structural integrity along one or more directions defined by the member. For example, the flat members may have high compressive strength along the length of the flat member in a direction which is parallel to the largest face of the flat connecting member, including, for example, a y direction when considering the flat member being positioned within an x-y plane. Non-limiting examples of suitable materials which may be used to produce the flat members includes: cardboard, reinforced paper materials, wood, plastics (e.g. PET, HDPE, PVC, PP, LDPE, PC), resins, polymers, metals, aluminum, plant based natural fibers, artificial fibers, animal derived fibers, composites thereof, and any other materials which can be used to produce a flat sheet having structural integrity, e.g. an adequate degree of compressive strength, along at least one direction. In addition, the plurality of flat members may also be referred to as support members, and the members need not be flat so long as they have structural integrity along one or more directions and are reasonable compact.

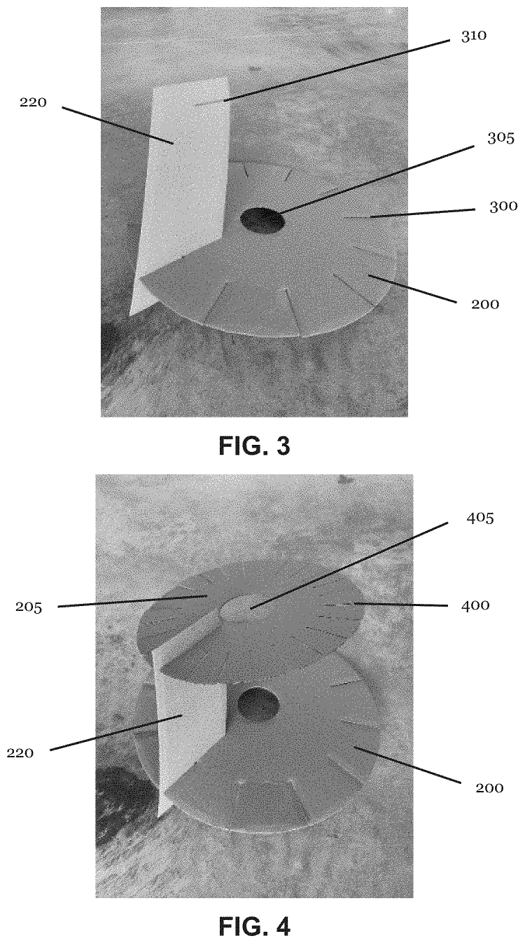

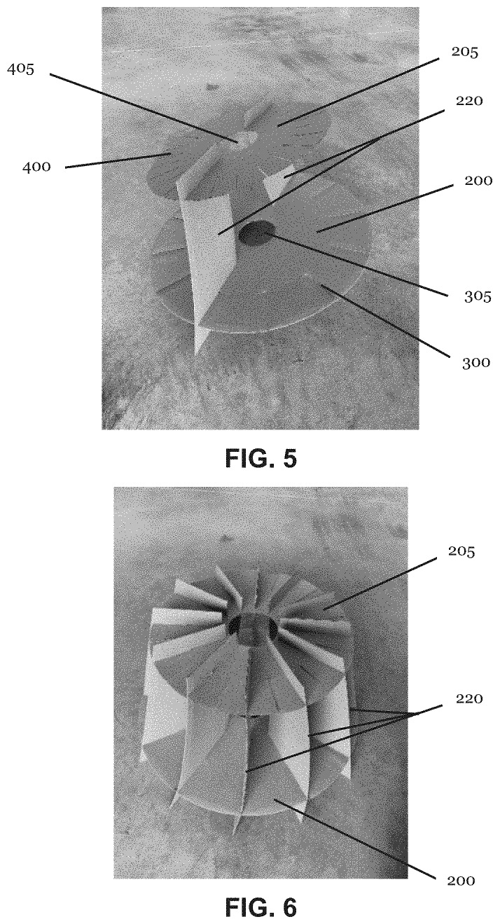

Referring to FIGS. 3-6, the improved model construction kit may include a plurality of supporting flat members which can be assembled to form a hollow frame, and, for example, a lower-mid level of a hollow frame. The plurality of supporting flat members may generally include one or more flat base members, and a plurality of flat connecting members possibly configured to connect to one or more flat base members, to form a hollow frame. For example, the first flat base member 200 may form the base of the structure, may have a plurality of connecting slots 300 surrounding the perimeter or circumference of the member, and a first hollow ring 305 in the center of the member. For example, the first flat connecting member 220 may have one or more connecting slots 310 which are configured to attach to the connecting slots 300 of the first flat base member 200.

A second flat base member 205 may also comprise a plurality of connecting slots 400 surrounding the perimeter or circumference of the member, a second hollow ring 405 in the center of the member, and may attach to the first flat connecting member 220 at the corresponding connecting slots 310 in the first flat connecting member 220. For example, a first flat connecting member may be inserted into a connecting slot 300 in the first flat base member 200, and a connecting slot 400 in the second flat base member to form a partial structure with a hollow frame. This process may be repeated along the perimeter or circumference of the flat base members 200/205 until a sufficient number of the corresponding connecting slots 300/400 in each of the members are occupied with first flat connecting members 220 to have formed a partially assembled hollow frame. Not all of the corresponding connecting slots 300/400 in each of the members need be filled, and only some of them may be utilized depending on the intended structure, and available materials. Larger and more complex structures may require additional support.

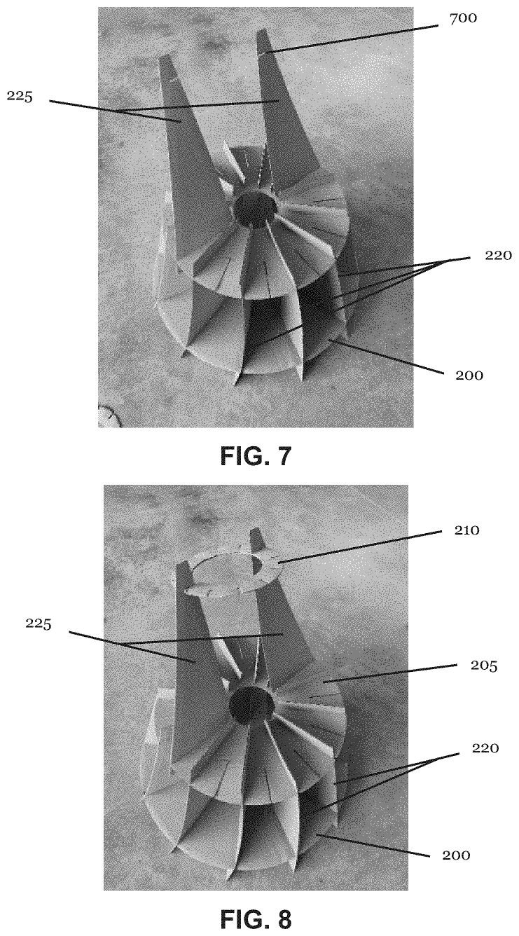

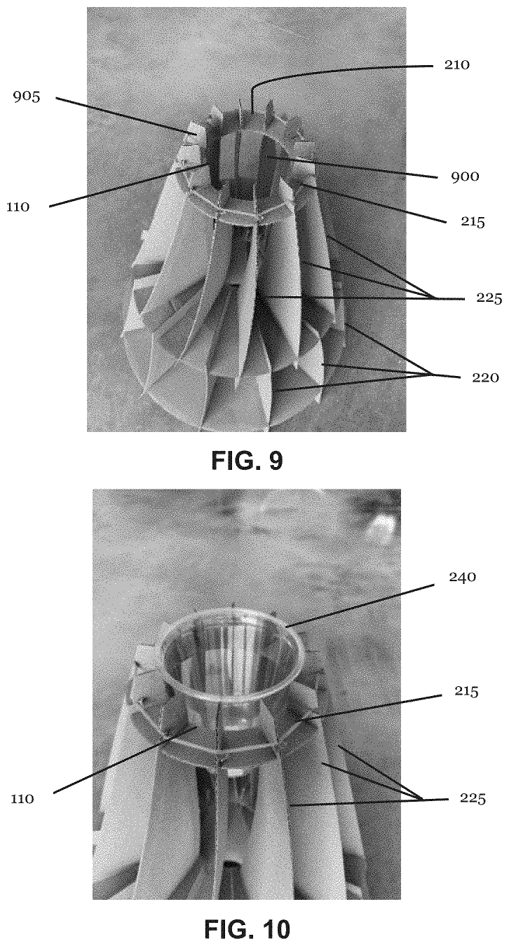

Referring to FIGS. 7-9, the improved model construction kit may include a plurality of supporting flat members which can be assembled to form a hollow frame, and, for example, a mid-upper level of a hollow frame. The second flat base member 205 may comprise additional, and possibly twice as many, connecting slots 400 along the circumference or perimeter of the member, as to accommodate for additional connecting members, possibly for use in constructing the upper level of the hollow frame. For instance, the first flat connecting members 220 may be arranged in the connecting slots 400 of the second flat base member 205 in an alternating fashion (e.g. every other one, even spaced), as to leave several of the connecting slots 400 of the second flat base member 205 open.

Subsequently, the open connecting slots 400 can then be attached to the plurality of second flat connecting members 225 to form the upper level of the hollow frame. The second flat connecting members 225 may also comprise connecting slots 700 cut into the member and which correspond to the connecting slots 400 of the second flat base member 205, to facilitate attachment of the second flat connecting members 225 to the second flat base member 205.

Following attachment of the second flat connecting members 225 to the second flat base member 205; the second flat connecting members 225 can then be attached to a third flat base member 210 to form the upper level of the hollow frame. The third flat base member 210 may similarly comprise a plurality of connecting slots 905 positioned around the circumference or perimeter of the member. As with the other flat base members, the third flat base member 210 may have a hollow ring 900 in the center of the flat base member.

Following attachment of the second flat connecting members 225 to the third flat base member 210, a fastener 215 may be used to connect the upper ends of the second flat connecting members 225 together. The fastener or fastening member may be an elastomeric material, for example, a rubber band, which may be inserted into connecting slots on the outside edge of the second flat connecting members 225 and which may help to hold the hollow frame into a desired shape. However, the fastener or fastening member is not limited thereto and could be any suitable fastening structure known within the art, such as a string, rope, wire tie, clasp, or other integrated fastening structure for connecting the second flat connecting members 225 together.

The hollow frame disclosed herein could also be created with different structures to achieve the same benefits, for example, plastic rods with fasteners to connect to each other may be utilized, or any other structure with a sufficient compressive strength along at least one direction and which also has a low vertical profile. By using structures with a sufficiently high compressive strength along one direction (which only need be strong enough to support the model weight), and which have a low vertical profile; the objective of maximizing profitability by reducing material costs (for both the supporting structures which form the hollow frame and the plaster which goes on top) and reducing logistical costs in producing, storing, and shipping bulky structures, can be realized.

For example, the plastic rods may be segmented into parts of various lengths, and may attach to each other by using male/female connectors on the ends of the rods, with each end of a rod having a male or female piece, or, alternatively, using female connectors with each rod having a male piece at both ends. The female connectors may have various insertion points which hold the rods in at particular angles, as to allow for more complex models with more precise angles to be built (e.g. a truss building structure model). In such an example, it may be educational for the user to compare and contrast the strength and materials used in the construction of various models (e.g. frame compared to truss). In a given embodiment, for example in the above described rod embodiment, the rods may be described as a plurality of support members, a plurality of frame members, a plurality of posts, a plurality of rods, a plurality of stakes, or a plurality of structural members, or any other language which is sufficient to describe the materials which compose the hollow frame, in addition to being described as a plurality of flat members.

In such embodiments, the savings in materials from the first material which forms the first surface may still be achieved because the hollow frame which serves as the supporting structure for the first surface may remain intact. For example, plaster wrap may still be utilized as a material for the first surface, and may be laid on top of the hollow frame in the same manner as described above with respect to the plurality of supporting flat members.

Referring to FIG. 10, there may be an opening 110 at the top of the hollow frame defined by the tops of the second flat connecting members 225, and a reactant vessel 240 may be positioned to sit atop the opening. The reactant vessel may contain a variety of different materials depending on the intended purpose of the structure. For example, it may contain water if the structure being modeled is a water tower or a chemical storage tank, it may contain rocks or other heavy material if the structural integrity of a design is being tested, or it may contain chemicals (e.g. NaHCO₃ (sodium bicarbonate/baking soda), CH₃COOH (acetic acid/vinegar), C₆H₈O₇ (citric acid), pressurized CO2 within a water soluble shell (Pop Rocks®, Coca-Cola®, or Mentos®, among many other possible combinations), if the buildup of pressure and gas, and release of energy, within a bounded environment is being simulated.

The kit may further comprise powdered reactants in embodiments of the kit drawn to a model volcano. For example, the kit may contain separately packaged powered chemical reactants such as powdered NaHCO₃ sodium bicarbonate, and powdered C₆H₈O₇ citric acid. The powdered NaHCO₃ sodium bicarbonate and C₆H₈O₇ citric acid will not immediately react in a solid powder state, and thus a final reactant mixture can then be prepared and inserted into reactant vessel 240. Following insertion of the final reactant mixture to the reactant vessel, water can then be added to form a solution in which the NaHCO₃ sodium bicarbonate, and powdered C₆H₈O₇ citric acid will rapidly react to release energy and CO2 gas, causing an “eruption” from the model volcano. Additional components can also be added to the reactant mixture such as pressurized CO2 within a water-soluble shell (e.g. Pop Rocks®) which will also release gas upon contact with water, or even Coca-Cola® and Mentos® which are known to produce large amounts of gas upon contact. The powdered chemical reactants may also contain dried dyes, such as red dye in the citric acid powder and yellow dye in the sodium bicarbonate powder, as to give the resulting solution and red, yellow, or orange color to more closely simulate lava. The dried dyes may be acrylic paints, or other suitable dyes which can be dried, and reconstituted with water, may be in either or both reactant mixes, or packaged separately.

The reactant vessel 240 can be composed of a variety of materials, and may be composed of a water-insoluble, hard, impervious material as to accommodate various fillings, such as a plastic polymer, or aluminum. The vessel may be a variety of shapes such as a cup, tube, straw, sphere, ovoid, polygonal prism, a relatively larger volume sized vessel connected to a relatively small and narrow spout positioned above the larger volume vessel, or a wholly enclosed vessel designed to burst or release pressure after building to the desired point. In a given embodiment of a model volcano, there may be a cup reactant vessel positioned near the top of the structure, a vessel positioned in the center or towards the bottom of the structure connected to the top of the structure by a tube or straw, or an enclosed vessel, possibly connected to a tube or other structure with a value or pressure release mechanism at the top, as to illustrate the effects of increased pressure and a sudden release of gas and energy within a bounded volume traveling upwards. In such a configuration, the tube may lead to the top of the hollow frame, and an opening of the structure.

In addition, there may also be additional separating structures connected to the reactant vessel which allow for more elaborate “eruptions” when combining the reactant mixture with water. For example, there may be a “trap door” which the reactant mixture can be placed on top of, with water being stored underneath, and the door can then be tripped by using a latch which is accessible from the exterior of the structure. The latch may be a spring mechanism, an elastic material which is deformed upon application of pressure, a button, or a rotary arm which is connected to a shaft that allows the latch to be tripped from outside the structure, possibly by rotating the shaft.

In one or more embodiments, the separating structure may be a component of a pressurized vessel which is used to simulate the effect of an eruption within a pressurized environment, and the latch may be secured with gaskets or another structure which allows pressure to be maintained within the vessel. In other embodiments, the separating structure may be included within a tube connected to and positioned above the reactant vessel as to allow for the reactants to be dropped down the tube and into the water as to provide a velocity to the reactants for a more explosive eruption as the acid/base solution reacts and bubbles up the tube to erupt outside of the volcano model.

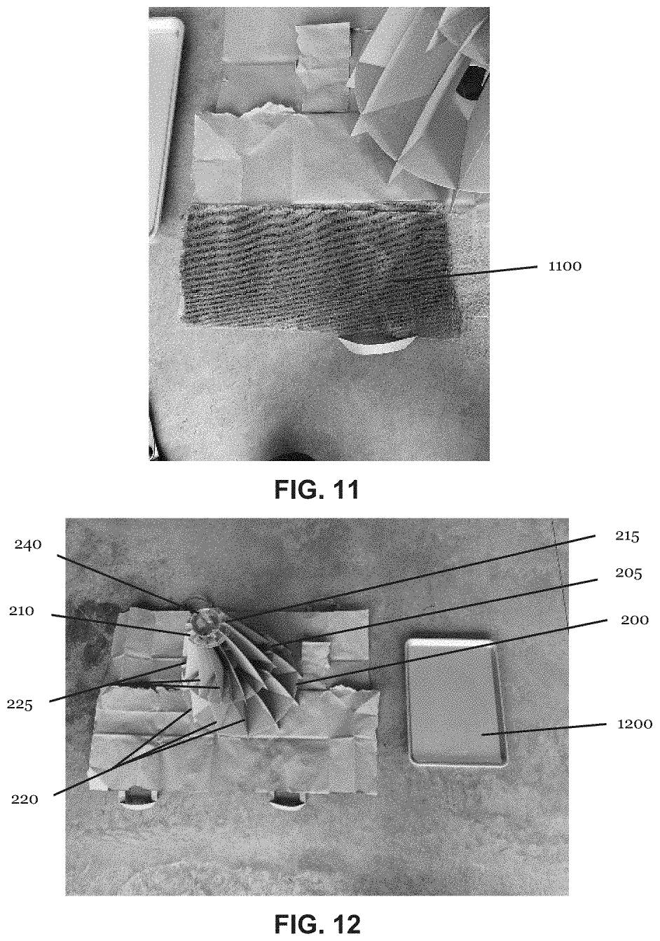

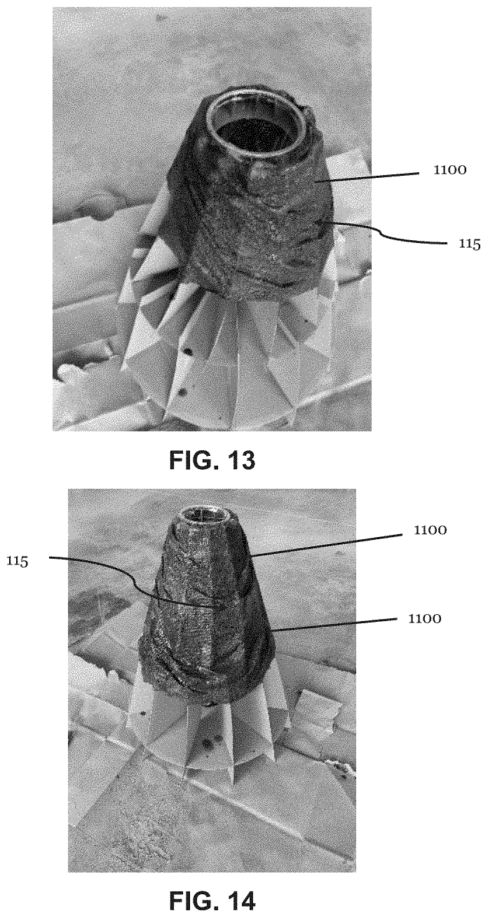

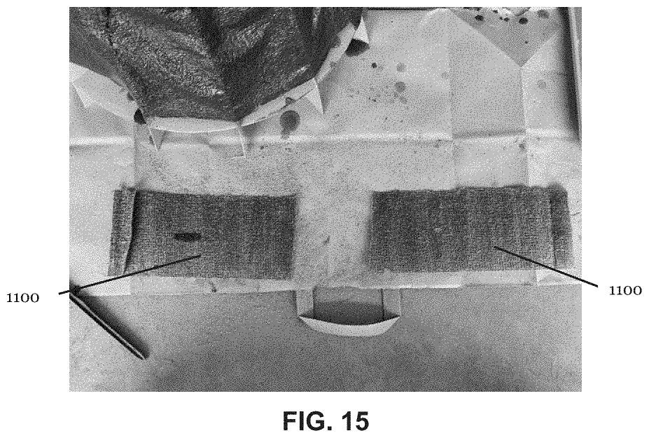

Referring to FIGS. 11-15, shown are perspective views of additional kit components of the model science kit of one or more embodiments, as well as assembly of an outer surface. The kit may include a pan 1200 suitable for saturating cut sheets 1100 of the plaster wrap in water to make it moldable and self-adhering. The plaster wrap 230 may be a fabric or gauze which contains an adhesive, gypsum, or other binding agent that is activated upon saturation with water, and dries to form a hard surface. The plaster wrap 230 can be cut to size, possibly a size suitable for saturation in the pan 1200, and then soaked in the water for about 5 seconds to activate the adhesive. Then plaster wrap can be laid on top of the hollow frame to cover the space between the connecting members 220/225 to form a first surface 115. This process can then be repeated until the entirety of the hollow frame is covered by the sheets 1100. The plaster wrap may be a gray or other dark color as to more closely match the appearance of a volcano or other natural volcanic rock which is commonly grey or black. The plaster wrap may be crafting grade plaster wrap, medical grade plaster wrap, or any other suitable grade of plaster wrap which is sufficient to form the hardened first surface upon drying. Following application of the plaster wrap to the hollow frame to create a first surface 115, the plaster wrap may be allowed to dry, and may dry in as little in 20 minutes in warm, dry conditions.

Other methods of forming a first surface atop the hollow frame other than by using plaster wrap may also be utilized. For example, it may be possible to create the first upper surface by using tape (single or double sided) to wrap the hollow frame, paper in combination with a small amount of adhesive, folded paper, sheets of aluminum foil, fabric, or plastic wrap, among other possible options. By producing a hollow frame with a first surface to serve as a support structure for a subsequent second surface, many of the benefits of the present embodiments can still be obtained, notwithstanding the use of different materials. In another embodiment, the first surface may be prepared by surrounding the frame with a fabric, non-woven fabric, or a paper cover. The plaster, or another material capable of creating a composite, can then be placed on top of the fabric or paper cover to create an outer shell, possibly the first surface, upon which a second surface can be constructed, as described in greater detail below.

In one or more embodiments, an additional method of constructing a first surface atop the hollow frame other than by using plaster wrap may also be utilized. For example, it may be possible to create the first upper surface by using a cone provided with the kit to be placed on top of the hollow frame, possibly a fabric cone. In this manner, it may be possible to avoid using plaster wrap which may require water and adhesive. The fabric cone may be provided as a flat sheet which is connected along one or both exterior edges of the sheet in order to form the sheet into a cone. The edges may be fastened together by using glue, interlocking ridges within the sheet material, string, rope, wire, clasps, clips or any other suitable integrated fastening structure for connecting the sheet together into a cone shape known within the art. Alternatively, the cone may be provided already fastened into a cone shape, possibly be being sewn, and it may be possible to compress the pre-fastened cone into a flat shape for convenient storage and shipping in the kit, including, for example, a fabric cone which may be elastically deformed/compressed to be flat without losing its cone shape or structural integrity. The fabric cone may be made out of any suitable material, natural fibers, or synthetic fibers, including, for example, cotton, polyester, linen, jute, bamboo, spandex, elastic, elastin, twill, or combinations thereof, among other possible materials.

Following construction of the plaster wrapped model with a first surface 115, an additional plaster second surface may be laid on top of the plaster wrap first surface 115. Powdered plaster may be included in the improved model kit, and the plaster powder may by gradually added to water while stirring the mixture to produce the plaster mix. It may be desirable to completely blend the powder into the mix using a volume of water and an amount of plaster to produce a thick, but pourable, mixture. The mixture may be allowed to set in order to further thicken if necessary. Once the mixture has been prepared, the plaster may be laid on top of the frame's first surface 115 and smoothed with a plaster applicator to produce a hardened second surface. The final plaster structure may be allowed to dry for 1-2 days before subsequent painting or use. The plaster may be a gray or other dark color as to more closely match the appearance of a volcano or other natural volcanic rock which is commonly grey or black.

Following drying, the plaster structure may be painted by the end user. The improved construction kit may include a number of different colored paints. It may be desirable to allow the paint to dry prior to any experiment involving wet chemicals which may cause the paint to run.

Prior art model science kits with non-miniaturized models are difficult to profitably commercialize due to the high materials costs, and other logistical costs in producing, storing, and shipping bulky structures. Many prior art structures utilize large molds which are entirely filled with plaster to produce a model volcano structure, which increases the cost of the kit both because of the material used in the mold itself, as well as the plaster which must be used to fill the mold. This also increases the size of the kits because the mold necessary must be hollow and larger in volume, making the kits larger, and costlier to store and ship. Solutions to this problem utilized by prior art model kits are typically to miniaturize the models, which is undesirable because it makes the models more difficult to work with, and results in a poor visual representation.

Applicant discloses methods and structures which allow for larger sized models to be produced with minimal materials, thus reducing the cost of production, allowing for larger sized models to be profitably commercialized. By utilizing a plurality of supporting flat members each comprising at least one connecting slot for attachment to other members; significant space and material may be saved when manufacturing model construction kits. The use of substantially flat structure with a low vertical profile relative to the large lengths of the members significantly reduces the amount of material which is needed to build a model structure.

For instance, the plurality of supporting flat members can have relatively high compressive force along one or more directions which are parallel to the face of the members. Since the members are flat, having a low vertical profile, they can also be stored on top of one another in a minimal space. This both reduces the cost of the materials, as well as logistical costs in producing, storing, and shipping bulky structures.

Applicant further reduces material costs and saves space by using the plurality of supporting flat members to create a hollow frame, which is then wrapped in plaster wrap, or other suitable material, and finished. The use of plaster wrap to create a first surface that sits atop the hollow frame saves significant plaster material relative to use of a mold to create a similarly sized structure. By supporting a relatively thin layer of plaster atop a first surface on an otherwise hollow frame, the amount of plaster used in the kit can be greatly reduced in comparison to methods which utilize a mold that needs to be filled with plaster. In one or more embodiments, the plaster may be placed on top of the first surface and can be used to form different geographical features of the model, such as mounds, bumps, rocks, or other decorative structures, as opposed to forming the bulk of the model itself. In such embodiments, the amount of plaster used in constructing the model may be reduced by 95% or more when compared to existing methods utilizing a mold filled with plaster. For example, if the same sized model volcano was prepared in a standard fashion of pouring a solid item, the total volume would be approximately 1776.80 cubic inches, and this would equate to approximately 36 lbs of plaster or 16.3293 kg (assuming the density of plaster is 53 lb/ft cubed). In one embodiment, the amount of dried plaster provided in the improved model kit may be about 1.8 lbs, and may weigh only a few pounds when hydrated with water, using 5% of the amount of plaster by comparison to preparation in a standard fashion.

An additional benefit achieved by the use of a plurality of support members (e.g. plurality of flat members) is that the model building kits are highly modular, and scalable. Because the support members can be connected together in a variety of different ways, and will have high compressive force along one or more directions; a variety of different structures of different size and different shape can be built, as is described herein. For instance, volcanos or mountain models of various size can be built based on the preference of the user, or building models of differing size and shape can be constructed using the same methodology of forming a hollow frame, and then constructing a first surface atop the hollow frame. This is advantageous to the end user who can build a model to suit their individual needs and preferences without having to purchase a different kit for each specific model.

One of ordinary skill in the art will recognize the inventive principles disclosed are not limited to the embodiments disclosed herein, and that various aspects of the disclosed embodiments can be combined to achieve additional embodiments. The applications of the present invention have been described largely by reference to specific examples and in terms of particular allocations of functionality to certain components. However, those of skill in the art will recognize that the invention can also be produced by components that distribute the functions of embodiments of this invention differently than herein described. Such variations and implementations are understood to be captured according to this disclosure, the following claims and their equivalents.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present invention relates to “one or more embodiments of the present invention.” Expressions, such as “at least one of,” when preceding a list of elements, modify the entire list of elements and do not modify the individual elements of the list. Also, the term “exemplary” is intended to refer to an example or illustration. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

The terminology used herein is for the purpose of describing particular example embodiments of the present invention and is not intended to be limiting of the described example embodiments of the present invention. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

What is claimed is:

1. A model science kit comprising:
a plurality of flat members each comprising at least one slot;
a first material which is in a shape of a flat sheet when fully extended, and which becomes self-adhering when saturated with water and which dries into a hardened material;
a second material which becomes moldable when saturated with water and which dries into a hardened material,
wherein the plurality of flat members are configured to interconnect with each other to form a hollow frame,
wherein the first material can be laid over the hollow frame to form a first surface, and
wherein the second material can be laid over the first surface to form a second surface.

2. The model science kit of claim 1, wherein the plurality of flat members further comprise a plurality of flat base members each comprising at least one slot, and a plurality of flat connecting members each comprising at least one slot,
wherein the plurality of flat connecting members are configured to connect to two or more flat base members to form the hollow frame.

3. The model science kit of claim 2, wherein the kit is a model volcano science kit, and
wherein the plurality of flat base members each has a hollow ring in a center of the flat base member.

4. The model science kit of claim 3, wherein the kit further comprises:
a fastening member configured to attach to the plurality of flat connecting members;
a first reactant mix;
a second reactant mix; and
a reactant vessel,
wherein the first reactant mix and the second reactant mix chemically react with each other to produce a gas, and
wherein a dye is present in at least one of the reactant mixes.

5. The model science kit of claim 4, further comprising:
a tube attached to the vessel which leads to a top of the hollow frame; and
a separating structure which is configured to releasably separate the first reactant mix and the second reactant mix from one another, and which is configured to cause the first reactant mix and the second reactant mix to combine when released.
